(19) United States
(12) Patent Application Publication
(10) Pub. No.: US 2009/0132571 A1
(43) Pub. Date: May 21, 2009

(54) EFFICIENT USE OF RANDOMNESS IN MIN-HASHING

(75) Inventors: Mark Steven Manasse, San Francisco, CA (US); Frank D. McSherry, San Francisco, CA (US); Kunal Talwar, San Francisco, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/941,081

(22) Filed: Nov. 16, 2007

(51) Int. Cl. G06F 17/30

(52) U.S. Cl. 707/102; 707/E17.011

(57) ABSTRACT

Documents that are near-duplicates may be determined using techniques such as min-hashing. Randomness that is used in these techniques may be based on sequences of bits. The sequences of bits may be generated from a string of bits, with the sequences determined by parsing the string at each occurrence of a particular value, such as the value “1”.

### BACKGROUND

Large collections of documents typically include many documents that are identical or nearly identical to one another. Determining whether two digitally-encoded documents are bit-for-bit identical is straightforward, using hashing techniques for example. Quickly identifying documents that are roughly or effectively identical, however, is a more challenging and, in many contexts, a more useful task.

The World Wide Web is an extremely large set of documents, and has grown exponentially since its birth. Web indexes currently include approximately five billion web pages, a significant portion of which are duplicates and near-duplicates. Applications such as web crawlers and search engines benefit from the capacity to detect near-duplicates.

### SUMMARY

Documents that are near-duplicates may be determined using techniques such as min-hashing. Randomness that is used in these techniques may be based on sequences of bits. The sequences of bits may be generated from a string of bits, with the sequences determined by parsing the string at each occurrence of a particular value, such as the value “1”.

In an implementation, the sequences of bits may be of varying length. In an implementation, the sequences of bits may have additional bits added to them, with the number of additional bits being based on a predetermined number or function.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is a block diagram of a distributed computer system;

FIG. 2 is a block diagram of an implementation of a search engine system;

FIG. 3 is an operational flow of an implementation of a method of generating randomness for use in determining near-duplicate documents;

FIG. 4 is an operational flow of another implementation of a method of generating randomness for use in determining near-duplicate documents; and

FIG. 5 shows an exemplary computing environment.

### DETAILED DESCRIPTION

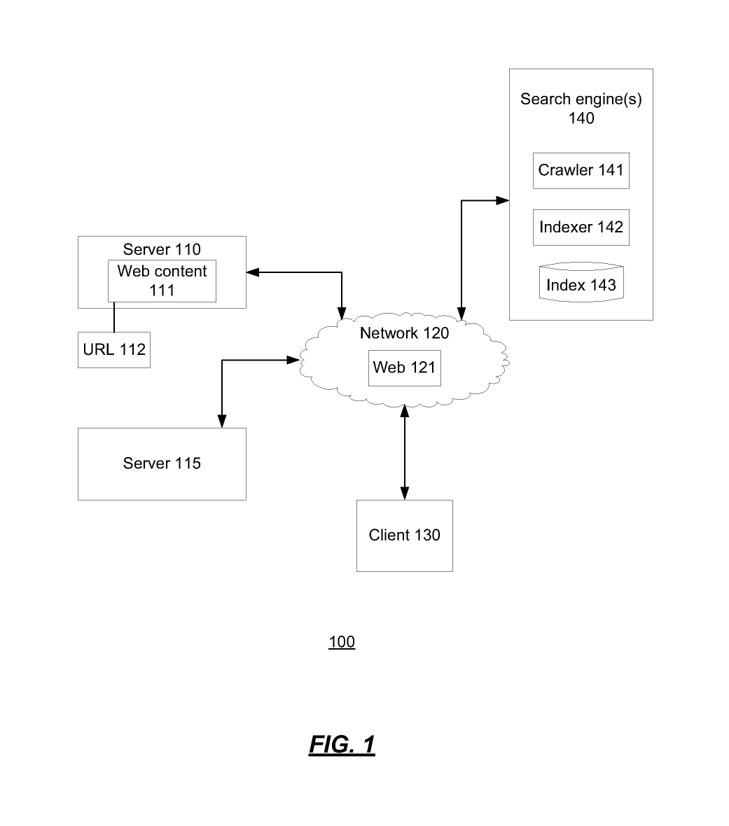

FIG. 1 shows an arrangement 100 of a distributed computing system which can use randomness as described herein. A plurality of server computers (referred to as servers) 110, 115 are connected to each other by a communications network 120, for example, the Internet. The Internet includes an application level interface called the World Wide Web (web 121). The servers maintain web content 111, which may comprise, for example, multimedia content such as web pages. The location of web content 111 is specified by its uniform resource locator (URL) address 112. Although only two servers 110, 115 are shown, any number of servers may be connected to the network 120 and to each other.

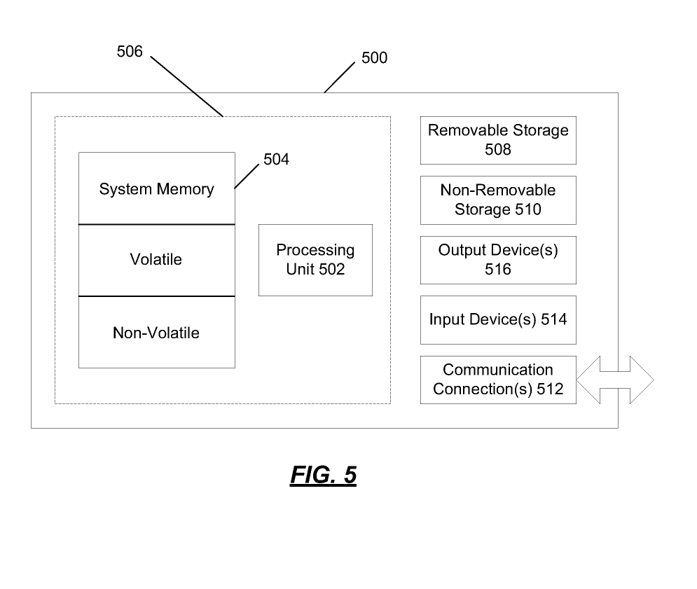

A client computer (referred to as a client) 130 may also be connected to the network 120. Although only one client 130 is shown, any number of clients may be connected to the network 120. An example client 130 is described in with respect to FIG. 5. Usually, the client 130 is equipped with a web browser. During operation of the arrangement 100, a user of the client 130 may monitor the web content 111 of the servers. The user may want to monitor specific content that has changed in a substantial way.

In order to assist the user of the client 130 to locate web content 111, one or more search engines 140 are also connected to the network 120. A search engine may use a crawler 141 to periodically scan the web 121 for changed or new content. An indexer 142 may maintain an index 143 of content located by the search engine. The search engine may also be equipped with a query interface to process queries submitted by users to quickly locate indexed content. A user of the client 130 may interact with the query interface via a web browser.

In systems like a large web index, a small sketch of each document may be maintained. For example, the content of complex documents expressed as many thousands of bytes can be reduced to a sketch of just hundreds of bytes. The sketch is constructed so that the resemblance of two documents can be approximated from the sketches of the documents with no need to refer to the original documents. Sketches can be computed fairly quickly, i.e., linear with respect to the size of the documents, and furthermore, given two sketches, the resemblance of the corresponding documents can be computed in linear time with respect to the size of the sketches.

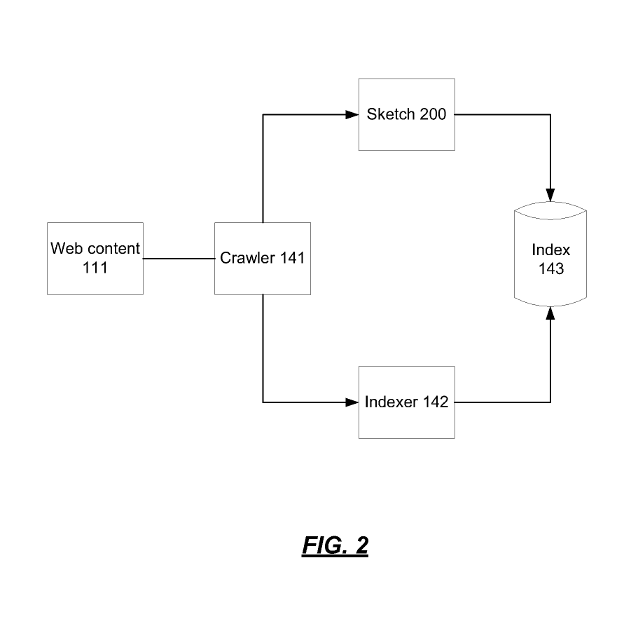

FIG. 2 is a block diagram of an implementation of a search engine system which can use randomness as described herein. The search engine may be used to provide a sketch 200 of each document of the web content 111 that is retrieved and indexed. The sketch 200 may be a bit or byte string which is highly dependent on the content of the document. The sketch 200 can be relatively short, for example, a couple of hundred bytes, and may be stored in the index 143 or other storage. As noted above, the sketches for documents can be determined in a time which is directly proportional to the size of the documents. By comparing resemblance estimates derived from sketches, it may be possible to determine whether documents are near-duplicates.

Documents are said to resemble each other (e.g., are near-duplicates) when they have the same content, except for minor differences such as formatting, corrections, capitalization, web-master signature, logos, etc. The sketches may be used to efficiently detect the degree of similarity between two documents, perhaps as measured by the relative intersection of the sketches. One way of doing this is to take samples from the document using a technique with the property that similar documents are likely to yield similar samples.

Many well known techniques may be used to determine whether documents are near-duplicates, and many of these techniques use randomness. Min-hashing is a technique for sampling an element from a set of elements which is uniformly random and consistent. The similarity between two sets of elements may be defined as the overlap between their item sets, as given by the Jaccard similarity coefficient. The Jaccard similarity coefficient is a statistic used for comparing the similarity and diversity of sample sets. The Jaccard similarity coefficient is defined as the size of the intersection divided by the size of the union of the sample sets. This is useful for determining near-duplicates of web pages.

Any known document comparison technique that can be used to measure the relative size of intersection of sketches may be used with the random values described herein. An exemplary version of a technique that uses min-hashing may compute a random value for each term in the document. The term that has the numerically least value may be set as a sample for that document.

There are several considerations involved in determining how to produce the random values that may be used with min-hashing or other techniques. Randomness is expensive, and as little of it as possible is to be used per term in the document. Additionally, arbitrarily accurate random values should be able to be produced to avoid possible ties in large documents. The randomness also may depend only on the term in question, and not be shared across multiple terms. A technique is reproducible so that if another document contains the same term, it produces exactly the same value. Moreover, randomness is not efficiently produced one bit at a time, but rather in bulk. Many samples may be produced in parallel, and randomness may be shared across these samples.

In techniques that use min-hashing, each document may be mapped to an arbitrarily long string of 0s and 1s. The largest number is used as the result to a query. If there is a tie, more bits may be evaluated, as described further herein.

A first known technique that may be used to determine the result to a query may compute 128 bits of randomness for each term and each parallel sample. The number of bits used is generally enough to avoid ties in any document that may be considered, and is an amount of randomness that is efficiently produced at a single time. However, the number of bits may be excessive, in that all 128 bits may generally not be needed to determine that a sample will not be worth pursuing as the largest number (i.e., the result to the query).

Another known technique takes 128 bits of randomness and divides it into 16 groups of 8 bits. Each of 16 parallel samples (i.e., terms in a document) takes these values as their first 8 bits. In many cases, these 8 bits will be sufficient to establish that the sample (i.e., the term) will not be competitive for the title of “least value”, because it is already larger than the value of another candidate sample, in which case the sample being considered may be discarded. Otherwise, a further 128 bits may be produced to determine the precise value. This technique uses far fewer bits on average, as most of the parallel samples will not be feasible, and only 8 bits are consumed for those samples.

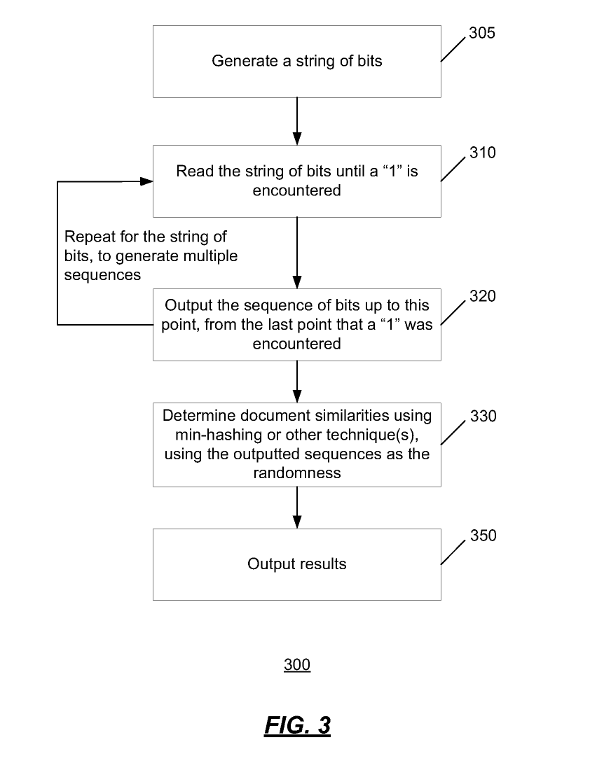

FIG. 3 is an operational flow of an implementation of a method 300 of generating randomness for use in determining near-duplicate documents. As described further herein, a random string of bits is parsed into sequences of bits, with each sequence of bits ending with the same value.

At stage 305, a random string of bits is generated. The string of bits is read until a value of “1” is encountered, at stage 310. Although the implementations described herein read bits until a value of “1” is encountered, implementations may read bits until a value of “0” is encountered, with the subsequently described stages being adjusted accordingly.

At stage 320, the sequence of bits up to the point of encountering the “1”, from the last point that a “1” was encountered is output. The output includes the most recently encountered “1”-valued bit, as well as the bits preceding that bit up to, but not including, the previous occurrence of a bit having a “1” value. Stages 310 and 320 are repeated for the string of bits, to generate multiple sequences of bits.

The sequences of bits that are determined may be used as the randomness in techniques that determine document similarities (e.g., near-duplicates) using randomness. In an implementation, at stage 330, document similarities may be determined using min-hashing or other techniques, using the sequences determined above as the randomness. The results may be outputted at stage 350.

In an implementation, a string of 128 randomly generated bits are used in an adaptive manner, using even less randomness per sample. The 128 bits are not broken into fixed size batches of values (i.e., not a fixed number of bits), but rather, the string of 128 bits is read until a “1” is encountered, and then the sequence up to this point is outputted, from the last point that a value was outputted.

For example, the string:

1010101100010101111001010

can be parsed as

1 01 01 01 1 0001 01 01 1 1 1 001 01 0???

outputting the sequence of numbers

1, 01, 01, 01, 1, 0001, 01, 01, 1, 1, 1, 001, 01

and leaving the trailing 0 unused.

In an implementation, the outputted sequences are of varying length, giving more accuracy to those elements that are smaller. The numbers all imagine a leading “decimal” point (though they are binary, not decimal), and so the output beginning with “1” is bigger than one beginning with “0010”, despite the former looking like “one” and the latter looking like “ten”. Alternately, the sequence may be broken at the “0”s. For those values for which more randomness may be useful, an additional 128 bits may be produced for each of the elements. If further ties are to be broken, another 128 bits may be produced.

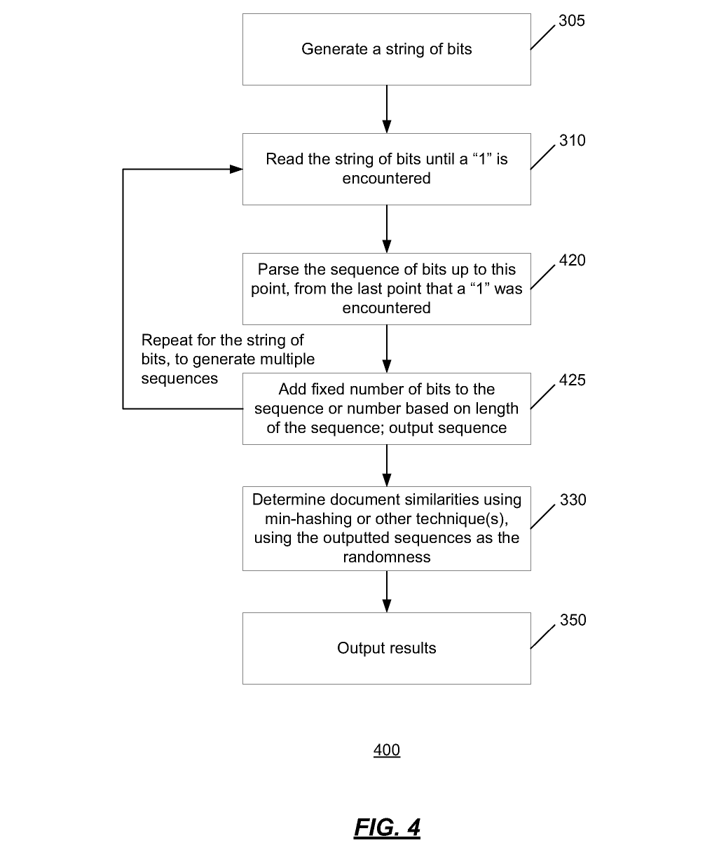

FIG. 4 is an operational flow of another implementation of a method 400 of generating randomness for use in determining near-duplicate documents. FIG. 4 contains elements similar to those described above with respect to the method 300 of FIG. 3. These elements are labeled identically. A random string of bits is generated at stage 305, and the string of bits is read until a value of “1” is encountered at stage 310.

At stage 420, the sequence of bits up to the point of encountering the “1”, from the last point that a “1” was encountered, is parsed out of the string. As in the method 300, the sequence includes the most recently encountered “1”. At stage 425, additional bits, perhaps randomly generated, may be added to the sequence of bits. The number of additional bits that may be added may be fixed (e.g., the same number of bits are added to each parsed sequence of bits) or variable (e.g., based on the number of bits in the parsed sequence of bits). The sequence of bits may be outputted.

Stages 310, 420, and 425 are repeated for the string of bits, to generate multiple sequences of bits. Processing may continue at stage 330, as described above with respect to the method 300 of FIG. 3.

In an implementation in which the number of bits added at stage 425 is variable, as many bits are added as are present in the bit sequence leading up to the “1”. In an implementation, if i bits are consumed in arriving at the “1”, a number f(i) additional bits may be added to the bit sequence. The larger the value of i, the more likely this value is to be among a tie of documents. Moreover, large values of i are very infrequent, so allocating more bits comes at a very small expected cost. Domain knowledge becomes helpful at this point, if there is understanding about expected document lengths, the number f(i) can be chosen to put additional resolution at the range of values that are likely to be of interest.

In an implementation, the expected consumption of randomness may drop to 2 bits per sample, plus whatever is needed to break ties. By deferring tie-breaking until after the bit sequences have been determined, only rarely will ties be broken among a large set, leading to an expected use of 2 bits per entry, plus an expected at most 192 bits (64 bits+128 bits) per set to break ties, for example. If ties are broken as soon as they are encountered, this value may be multiplied by the logarithm of the size of the set.

FIG. 5 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method of generating randomness for use in determining near-duplicate documents, comprising:
generating a string of bits;
parsing the string of bits into a plurality of sequences of bits, each sequence of bits ending with a bit having the same value; and
providing the sequences of bits as randomness to a technique for determining near-duplicate documents.

2. The method of claim 1, wherein the string of bits comprises a random string of bits.

3. The method of claim 1, wherein the technique for determining near-duplicate documents comprises a min-hashing technique.

4. The method of claim 1, wherein parsing the string of bits comprises:
reading the string of bits until a bit having a predetermined value is reached; and
outputting a portion of the string of bits that comprises the bit having predetermined value and bits preceding the bit having the predetermined value up to a previous occurrence of a bit having the predetermined value in the string of bits.

5. The method of claim 1, wherein the string of bits comprises a plurality of bits, each bit having a value of zero or one, and wherein each sequence of bits ends with a bit having the value of one.

6. The method of claim 1, further comprising:
repeating the generating and parsing stages to generate additional sequences of bits; and
providing the additional sequences of bits as additional randomness to the technique for determining near-duplicate documents.

7. The method of claim 1, further comprising adding a predetermined number of bits to each sequence of bits.

8. The method of claim 7, wherein the predetermined number of bits comprises randomly generated bits.

9. The method of claim 1, further comprising adding an additional number of bits to each sequence of bits, the additional number of bits being based on a number of bits in the associated sequence of bits.

10. The method of claim 9, wherein the additional number of bits equals the number of bits in the associated sequence of bits.

11. A randomness generating system, comprising:
a processor that generates a plurality of sequences of bits from a random string of bits, each sequence of bits comprising a number of bits from the random string of bits and each sequence having the same bit value at a position in the sequence; and
a memory that stores the sequences of bits.

12. The system of claim 11, wherein the position in the sequence is an end of the sequence.

13. The system of claim 11, wherein the number of bits in each sequence is the same.

14. The system of claim 11, wherein the processor adds a same predetermined number of bits to each sequence of bits.

15. The system of claim 11, wherein the processor adds an additional number of bits to each sequence of bits, the additional number of bits being equal to the number of bits in the associated sequence of bits.

16. The system of claim 11, wherein the processor provides the sequences of bits as randomness to a technique for determining near-duplicate documents.

17. A computer-readable medium comprising computer-readable instructions for generating randomness, said computer-readable instructions comprising instructions that:
parse a randomly generated string of bits into a plurality of sequences of bits, each sequence of bits comprising a bit of a same value in a position in the sequence; and
output the sequences of bits as randomness.

18. The computer-readable medium of claim 17, further comprising instructions that determine near-duplicate documents using the randomness.

19. The computer-readable medium of claim 18, wherein the instructions that determine near-duplicate documents comprise instructions for performing a min-hashing technique.

20. The computer-readable medium of claim 17, wherein the instructions that parse the randomly generated string of bits into the plurality of sequences of bits comprises instructions that:
read the string of bits until a bit having a predetermined value is reached; and
output a portion of the string of bits that comprises the bit having predetermined value and bits preceding the bit having the predetermined value up to a previous occurrence of a bit having the predetermined value in the string of bits.
